(19) United States
(12) Patent Application Publication
(10) Pub. No.: US 2011/0222283 A1
(43) Pub. Date: Sep. 15, 2011

(54) LED LAMP AND COOLING STRUCTURE THEREOF

(75) Inventor: Chyi-Lang LAI, Taipei Hsien (TW)

(73) Assignee: Chicony Power Technology Co., Ltd.

(21) Appl. No.: 12/720,828

(22) Filed: Mar. 10, 2010

(51) Int. Cl. F21S 4/00; F28F 7/00

(52) U.S. Cl. 362/249.02; 165/185

(57) ABSTRACT

An LED lamp with cooling structure includes a lamp tube, a LED module accommodated in the lamp tube and a cooling structure covering the outside of the lamp tube. The lamp tube has top plate and sidewall bended and extended from periphery of the top plate. The LED module includes circuit board attached onto inside face of the top plate and plural LEDs electrically connected onto the circuit board. The cooling structure has cover plate attached to outside face of the top plate and plural cooling fins bended and extended from periphery of the cover plate and interspaced to each other, in which the cooling fins cover the outside of the sidewall of the lamp tube and is formed a cooling channel with the sidewall. Thereby, an excellent efficiency of cooling is achieved and the manufacturing cost of the LED lamp is thus reduced.

### BACKGROUND OF THE INVENTION

1. Field of the Invention

The present invention in general relates to an LED lamp, in particular, to an LED lamp with cooling structure.

1. Description of Prior Art

Recently, because of flourishing and maturity of LED technique, further since of its merits of low energy consumption, long usage life, small volume and quick reaction, LED has gradually replaced traditional halogen bulb to become the mainstream of future market.

General speaking, the higher power of LED is, the more waste heat is generated. However, higher temperature has negative influence on lifespan and lighting efficiency of LED. Therefore, an LED, having higher power, will be arranged cooling structure to dissipate the waste heat in time. According to prior arts, a cooling structure of LED is usually arranged plural cooling fins at outside surface of lamp seat, whereby a cooling area in large range is used to accelerate the dissipating speed of the waste heat.

However, since of large area and quantity of cooling fins disposed on the outside surface of the lamp seat, further because of the lamp seat and the cooling fins usually integrally made by the processing methods of aluminum extrusion and casting, the mold is expansive and the manufacturing time is long. Moreover, since the defect of cooling fins is easily formed by collision during the transportation process, the product yield is further influenced, such that the manufacturing cost of LED lamp is at high position currently.

Accordingly, after a substantially devoted study, in cooperation with the application of relative academic principles, the inventor has finally proposed the present invention designed reasonably to possess the capability to improve the drawbacks of the prior arts significantly.

### SUMMARY OF THE INVENTION

Therefore, in order to solve aforementioned problems, the invention is mainly to provide an LED lamp which has excellent efficiency of cooling and has a lower cost of manufacturing.

Secondly, the invention is to provide an LED lamp which can be assembled simply and manufactured easily.

Thirdly, the invention is to provide an LED lamp, including a lamp tube, a LED module accommodated in the lamp tube and a cooling structure covering the outside of the lamp tube. The lamp tube has top plate and sidewall bended and extended from periphery of the top plate. The LED module includes a circuit board attached onto inside face of the top plate and plural LEDs electrically connected onto the circuit board. The cooling structure has cover plate attached to outside face of the top plate and plural cooling fins bended and extended from periphery of the cover plate to cover the outside of the sidewall of the lamp tube and formed a cooling channel with the lamp tube.

Fourthly, the invention is to provide a cooling structure of LED lamp which is made by a stamping method and is then formed by bending, so it can reduce manufacturing cost.

Fifthly, the invention is to provide a cooling structure of LED lamp which is arranged by covering over a lamp tube of LED lamp and includes a cover plate and plural cooling fins bended and extended from periphery of the cover plate to cover the outside of the sidewall of the lamp tube and form a cooling channel with the lamp tube.

Compared to prior arts, the LED lamp of the invention has following merits. First of all, different from the prior arts taking aluminum-extruded fins as a cooling structure, the cover plate and cooling fins of the LED lamp of the invention is firstly made by stamping method and then processed by bending, so the cooling structure can be formed as a mask body to cover the lamp tube. Therefore, the machining and assembling methods are simple without spending lots of money on mold preparation, so the manufacturing cost is reduced significantly. Furthermore, according to the cooling structure of the invention, a cooling channel is remained between the cooling fins and the sidewall of the lamp tube, so cool air at the outside can enter and carry part of the heat generated from the LED module, while the formed hot air is dissipated from the cooling holes of the cover plate, such that a natural convection with excellent performance of cooling can be achieved because of this kind of design, enhancing the practicability and economic profit of the invention.

### BRIEF DESCRIPTION OF DRAWING

The features of the invention believed to be novel are set forth with particularity in the appended claims. The invention itself, however, may be best understood by reference to the following detailed description, which describes a number of embodiments of the invention, taken in conjunction with the accompanying drawings, in which:

FIG. 1 is a perspective outer illustration showing an LED lamp according to the present invention;

FIG. 2 is a perspective explosive illustration showing an LED lamp according to the present invention;

FIG. 3 is a using illustration showing an LED lamp according to the present invention;

FIG. 4 is an LED lamp according to the second embodiment of the present invention; and

FIG. 5 is an LED lamp according to the third embodiment of the present invention.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

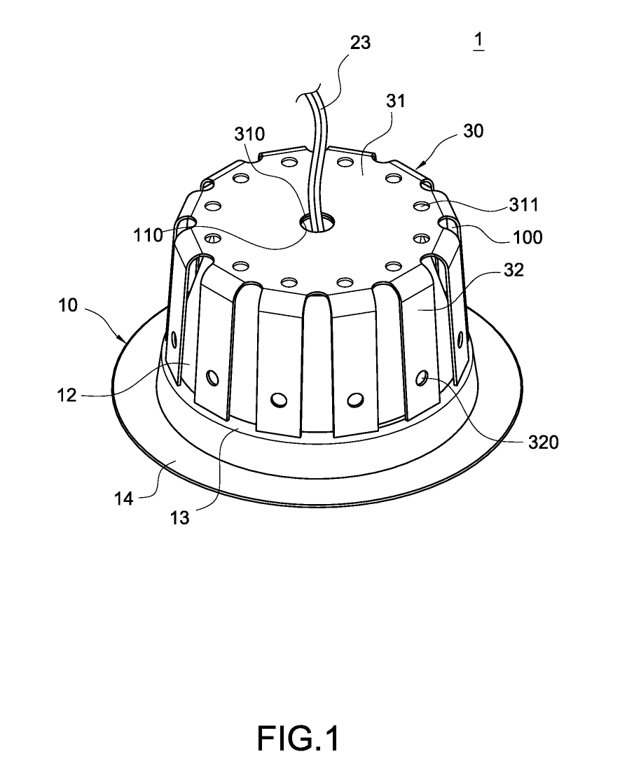

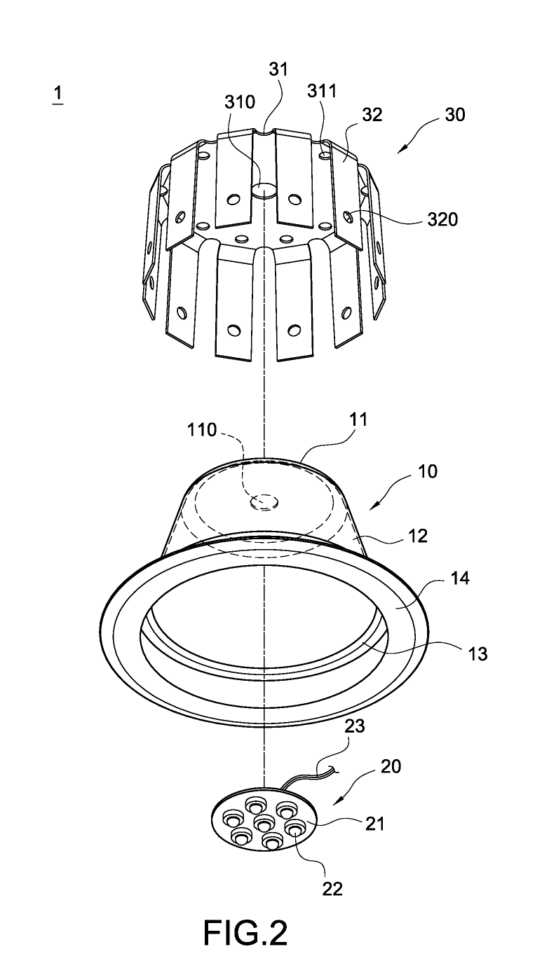

Please refer to FIG. 1 and FIG. 2, respectively showing a perspective outer and a perspective explosive illustration of an LED lamp according to the present invention. As shown in these two figures, the LED lamp 1 of the invention includes a lamp tube 10, an LED module 20 and a cooling structure 30.

The lamp tube 10 has a top plate 11 and a sidewall 12 bended and extended from the periphery of the top plate 11. Meanwhile, a perforation 110 is arranged at the middle place of the top plate 11. In this case, the lamp tube 10 is shown as a cone-like tube. In addition, a shoulder 13 is formed at and extended from the bottom edge of the sidewall 12, and a flange 14 is extended outwardly from the end side of the shoulder 13.

The LED module 20 is accommodated in the lamp tube 10 and includes a circuit board 21 and a plurality of LEDs 22. These LEDs 22 are disposed on the circuit board 21 and electrically connected thereto. The circuit board 21 is attached onto the inside face of the top plate 11 of the lamp tube 10 and has a wire 23 to provide power source.

In this case, the cooling structure 30 covers the lamp tube 10 and includes a cover plate 31 and a plurality of cooling fins 32 configured by being bended and extended from the periphery of the cover plate 31 and interspaced to each other. The cover plate 31 is attached onto the outside face of the top plate 11 of the lamp tube 10 and arranged a hole 310 corresponding to the perforation 110 of the top plate 11. The wire 23 of the LED module 20 passes through the perforation 110 and the hole 310. In this case, the connection manners between the cover plate 31 and the top plate 11 of the lamp tube 10 can be achieved by means of screws or thermally conductive glue.

Moreover, a plurality of first cooling holes 311 are arranged on the cover plate 11. These first cooling holes 311 are arranged in a ring configuration in the neighborhood of the periphery of the cover plate 11. In addition, these cooling fins 32 are shown as a radial ring, and each cooling fin 32 is arranged a second cooling hole 320. Meanwhile, the end side of the cooling fin 32 is a free end that is abutted onto the shoulder 13 of the lamp tube 10.

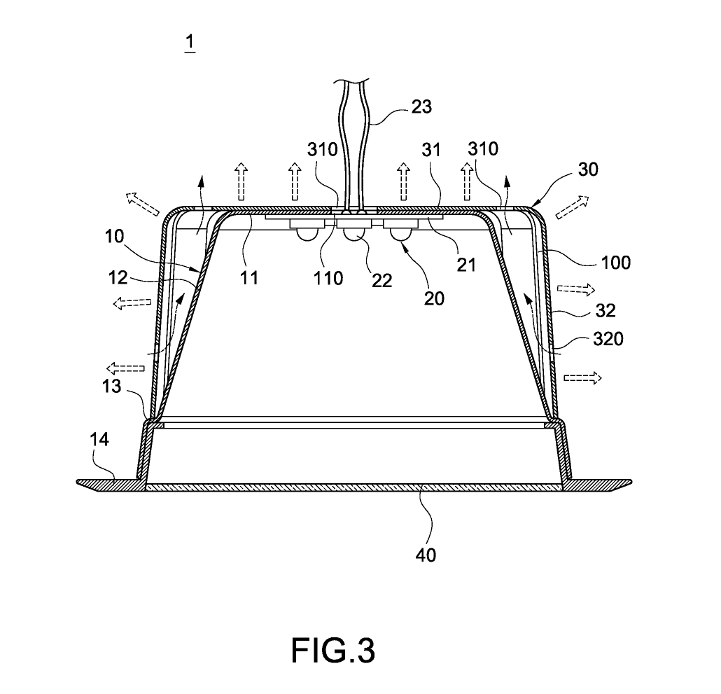

Please refer to FIG. 3, which is a using illustration of an LED lamp according to the present invention. As shown in this figure, at the opening of the lamp tube 10, the LED lamp 1 is further arranged a transparent shade 40 to prevent outside object, like mosquito and fly, from entering the lamp tube 10. In this case, these cooling fins 32 covers the outside of the sidewall 12 of the lamp tube 10 and is formed a cooling channel 100 with the sidewall 12. Thereby, when the LED lamp 1 provides illumination, the heat generated from the LED module 20 will be conducted to the top plate 11 of the lamp tube 10 via the circuit board 21, and further conducted to the cover plate 31 of the cooling structure 30 via the top plate 11, and finally the heat generated from the LED module 20 is dissipated to the ambiance via the cover plate 31 and the cooling fins 32.

In addition, since there is a cooling channel 100 remained between the sidewall 12 of the lamp tube 10 and the cooling fins 32 of the cooling structure 30, the outside cool air can enter the cooling channel 100 via the second cooling holes 320 of the cooling fins 32 and carry away part of the heat generated from the LED module 20. After being formed, the hot air can be dissipated to the environment via the first cooling holes 311 arranged on the cover plate 31.

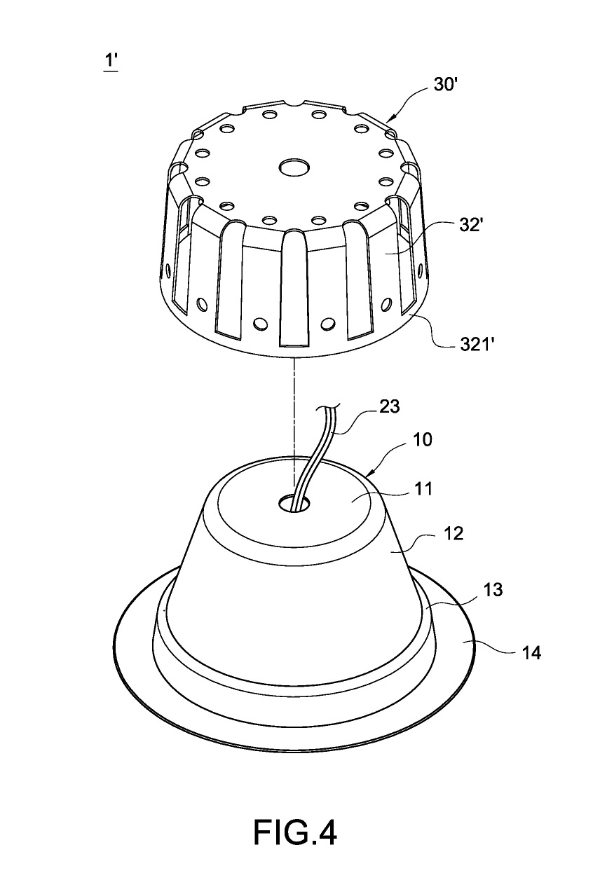

Please refer to FIG. 4, showing an LED lamp and a cooling structure thereof according to the second embodiment of the present invention. As shown in this figure, the second embodiment is substantially same as the first embodiment, except for the cooling fins 32′ of the cooling structure 30′ of the LED lamp 1′. In this embodiment, the end sides of these cooling fins 32′ are connected together to form a cover ring 321′. When the cooling structure 30′ covers the outside of the lamp tube 10, the cover ring 321′ is abutted onto the shoulder 13 of the lamp tube 10.

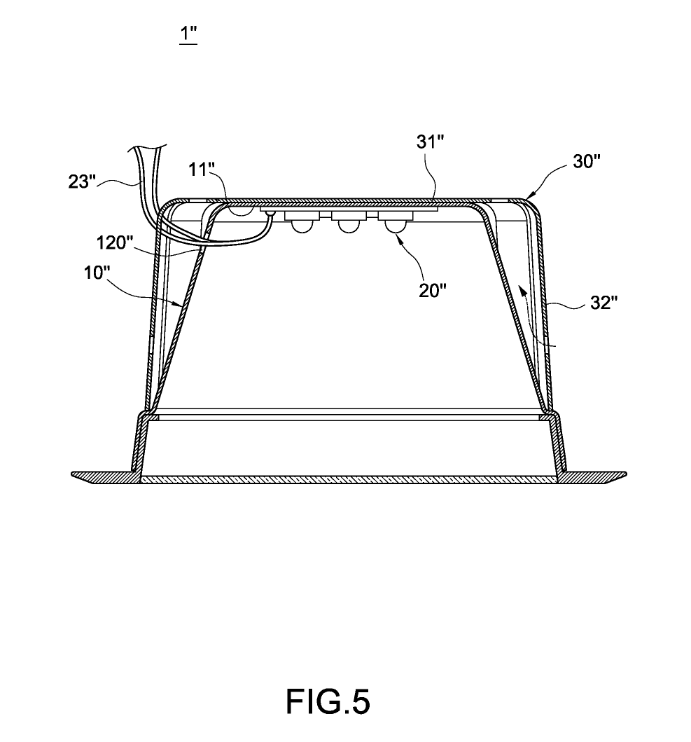

Continuously, please refer to FIG. 5, showing an LED lamp and a cooling structure thereof according to the third embodiment of the present invention. As shown in this figure, the third embodiment is substantially same as the first embodiment, except for the arrangement of the wire 23″ of the LED module 20″. In this case, a perforation 120″ is arranged at the sidewall 12″ of the lamp tube 10″. After passing through the perforation 120″, the wire 23″ again passes through the gap of the cooling fin 32″ of the cooling structure 30″ and is connected to the power seat at the outside. Therefore, there is no need to arrange any perforation on the top plate 11″ of the lamp tube 10″ and the cover plate 31″ of the cooling structure 30″. Thereby, the invention has a better performance of preventing external objects from entering the lamp tube 10″.

Therefore, through the constitution of aforementioned assemblies, an LED lamp and a cooling structure thereof according to the present invention is thus obtained.

Summarizing aforementioned description, the LED lamp with cooling structure according to the present invention is an indispensable device and design for a lighting industry indeed, which may positively reach the expected usage objective for solving the drawbacks of the prior arts, and which extremely possesses the innovation and progressiveness to completely fulfill the applying merits of a new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. An LED lamp, including:
a lamp tube, which has a top plate and a sidewall bended and extended from a periphery of the top plate;
an LED module, which is accommodated in the lamp tube and includes a circuit board attached onto an inside face of the top plate and a plurality of LEDs electrically connected onto the circuit board; and
a cooling structure, which covers an outside of the lamp tube and has a cover plate attached to an outside face of the top plate and a plurality of cooling fins bended and extended from a periphery of the cover plate to cover an outside of the sidewall of the lamp tube and formed a cooling channel with the sidewall.

2. The LED module according to claim 1, further including a transparent shade, wherein the lamp tube has an opening for the transparent shade to be combined thereon.

3. The LED module according to claim 1, wherein the cover plate is distributed a plurality of first cooling holes which are arranged by forming into a ring shape in a neighborhood of the periphery of the cover plate, and a shoulder is formed by being extended from a bottom side of the sidewall of the lamp tube, and a flange is extended outwardly from an end side of the shoulder, and these cooling fins are arranged by being interspaced at the periphery of the cover plate and abutted onto the shoulder, and each cooling fin is arranged a second cooling hole.

4. The LED module according to claim 1, wherein the circuit board has a wire, and the lamp tube has a perforation, and the wire passes through the perforation.

5. The LED module according to claim 1, wherein an end side of each cooling fin is a free end, and these cooling fins are arranged as a radial ring configuration.

6. The LED module according to claim 1, wherein end sides of the cooling fins are connected to each other to form a mask ring.

7. A cooling structure of LED lamp which is arranged by covering over a lamp tube of LED lamp and includes a cover plate and a plurality of cooling fins bended and extended from a periphery of the cover plate to cover an outside of the sidewall of the lamp tube and form a cooling channel with the lamp tube.

8. The cooling structure of LED lamp according to claim 7, wherein the cover plate is distributed a plurality of first cooling holes which are arranged as a ring configuration in a neighborhood of a periphery of the cover plate, and the cooling fins are arranged by being interspaced from the periphery of the cover plate, and each cooling fin is arranged a second cooling fin.

9. The cooling structure of LED lamp according to claim 7, wherein an end side of each cooling fin is a free end, and the cooling fins are arranged as a radial ring configuration.

10. The cooling structure of LED lamp according to claim 7, wherein end sides of the cooling fins are connected to each other to form a mask ring.
